(19) United States
(12) Patent Application Publication
(10) Pub. No.: US 2022/0015349 A1
(43) Pub. Date: Jan. 20, 2022

(54) Vermin Repellent Tape

(71) Applicant: Richard S. Toon, JR., Tulsa, OK (US)

(72) Inventor: Richard S. Toon, JR., Tulsa, OK (US)

(21) Appl. No.: 16/931,013

(22) Filed: Jul. 16, 2020

(51) Int. Cl. A01M 29/12; C09J 7/20

(52) U.S. Cl. CPC A01M 29/12; C09J 7/20

(57) ABSTRACT

A vermin repellent tape for repelling vermin such as mice, rats, and small animal such as squirrels, opossums, raccoons, bats, etc., comprising an adhesive layer that allows a user to place the vermin repellent tape in a desired location, a backing, a vermin repellent layer retaining the vermin repellent, and a release layer to controlling the emanation of the vermin repellent in the desired location thus repelling the undesired vermin. The user may place the vermin repellent tape in a desired location on a supporting surface within in equipment and the like to repel vermin.

### CROSS-REFERENCE TO RELATED APPLICATIONS

None.

### FIELD OF THE INVENTION

The invention generally relates to repelling vermin from a desired location for a desired length of time. In particular, the invention relates to an apparatus for repelling mice, rats, and other animals such as squirrels, raccoons, opossums, and bats (hereinafter referred to as “vermin”), wherein the tape is easily positioned by a user to repel the vermin by the release of the vermin repellent in a desired location.

### BACKGROUND

There are various methods of controlling vermin and other small animals including chemical, mechanical, biological, and a combination thereof. Chemical control uses poison baits to terminate the vermin. Additionally, many of the chemical controls are poisonous and dangerous to humans. Mechanical vermin control comes in several forms including entry proofing, trapping, and killing. Entry proofing requires any potential entry that may be used by vermin into an area that a user desires protected to be blocked using wire nets and the like to prevent entry. Trapping may be accomplished by trigger traps, cage traps, and glue traps. For some mechanical traps, a user must first bait the traps then inspect the traps regularly to remove the trapped and/or deceased vermin and potentially reset and rebait the trap. Some biological control may require understanding the vermin's ecosystem. Vermin thrive in certain environments and in an environment devoid of the natural predators including, but not limited to, cats, birds of prey, and snakes, vermin populations can greatly increase. Adding or increasing the predator population may not be an option as these animals may not stay in the area desired. Additionally, the predators may not be able to enter the equipment to catch the vermin. Vermin thrive in environments where they can hide and breed in a protected environment and equipment provides them such an environment. Trapping and killing the vermin is the most common method of controlling vermin but that does not prevent them for damaging the equipment beforehand.

The methods described above may be sufficient and effective to control vermin within a residence, a shop, and other types of buildings where persons tend to use. Additionally, the user may be required to inspect the traps periodically and remove the captured and killed vermin which requires constant monitoring. However, mobile environments such as vehicles and equipment do not lend themselves to the methods described above to protect them because of their mobility, openness, and periodic use. For example, a farm tractor, a lawnmower, and heavy equipment such as a bulldozer may be stored after the season and/or stored on location and may not be inspected until the next use, which may be a day, week, and/or months. These vehicles have accessible wiring that may be susceptible to damage by vermin for which entry proofing would be ineffective. Additionally, trapping and using baits may pose a threat to other animals such as family pets and other wild animals that are not the target. Any vermin that may be captured and killed may not be found for some time thus creating other problems including but not limited to biological hazards from the decomposition, smell, and the attraction of other animal and insects. Further, affixing traps and baits to the mobile environment is very difficult if not impossible for multiple reasons including, but not limited to space, temperature, and location.

The methods described above have significant disadvantages with respect to mobile environments, and they are ineffective in protecting mobile environments from vermin.

### SUMMARY OF THE INVENTION

The present invention overcomes these shortcomings by providing an apparatus that allows a user to select a desired amount of vermin repellent tape and affix the vermin repellent tape to a supporting surface in a desired location on where the vermin repellent is timely released to maximize concentration and length of effectiveness. The vermin repellent is not designed to injure or kill the vermin but instead uses their natural aversions to a particular aroma such as predator urine to repel the vermin. The user may place the vermin repellent tape near areas that may be susceptible to damage by vermin to prevent or minimize the damage. The vermin repellent tape may consist of an adhesive layer, a backing, a vermin repellent, and a release layer.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the present invention. Additional benefits and advantages of the present invention will become apparent to those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a perspective view of a vermin repellent tape.

FIG. 2 is a cross-sectional view of the vermin repellent tape of FIG. 1.

FIG. 3 is a top view of the release layer of the vermin repellent tape.

### DETAILED DESCRIPTION OF THE INVENTION

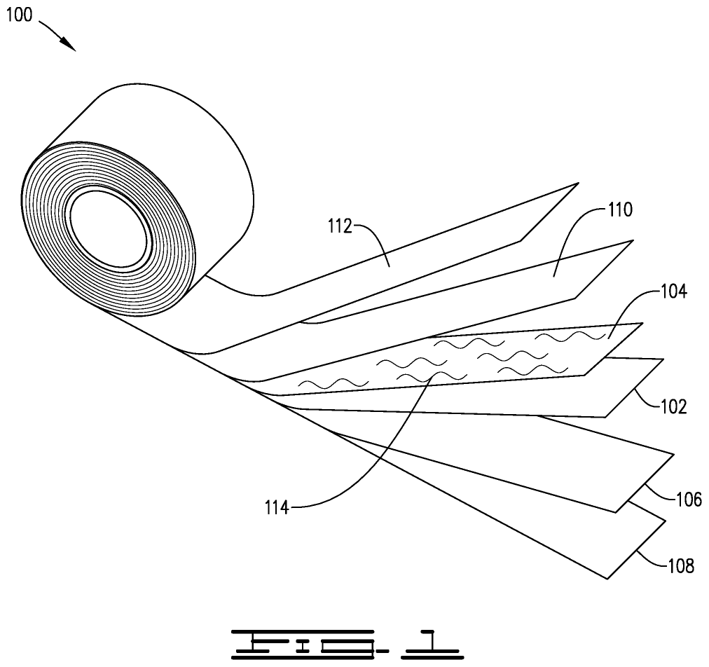

FIG. 1 is a perspective view of the embodiment of vermin repellant tape 100. A vermin repellant tape 100 may comprise a backing 102, a vermin repellent layer 104 impregnated with a vermin repellent 114, an adhesive layer 106, an adhesive protective layer 108, a control release layer 110, and a release protective layer 112. The backing 102 is the central body of the tape to which the other layers may build upon. The backing 102 has first face on the underside for affixing the adhesive layer 106 and a second face on the topside for affixing the vermin repellent layer 104. The backing 102 may be constructed from fabric, plastic, and cellulosic. Plastic is the preferred backing 102 for this embodiment.

The adhesive layer 106 has a first face to affix to the backing 102. Opposite of the first face of the adhesive layer 106 is a second face to be used for adhering to a support surface. This adhesive layer 106 allows a user to place the vermin repellant tape 100 in a desired area and to affix the vermin repellent tape 100 to a support surface. The adhesive layer 106 may contain an adhesive that may substantially adhere to most surfaces. Preferably, the adhesive layer 106 will be removeable from the support surface and not leave a residue. In the preferred embodiment, one skilled in the art may select a pressure sensitive adhesive for the vermin repellent tape 100, but other types of adhesives including, but not limited to, heat activated, and water activated adhesives.

The adhesive protective layer 108 has a first face to releasably affix to the adhesive layer 106. Opposite of the first face of the adhesive protective layer 108 is a second face to prevent damage to the adhesive layer 106. Different coatings may be applied to the second face of the adhesive protective layer 108 to prevent environmental degradation of the adhesive including but not limited to, ultraviolet protection. An adhesive protective layer 108 substantially covers the second face of the adhesive layer 106 until used to prevent inadvertent adhesion. The adhesive protective layer 108 may prevent the vermin repellent tape 100 from adhering to itself if stored in a roll or in a stack or other preferred method by one skilled in the art. The adhesive protective layer 108 allows a user to select a desired location, maneuver the vermin repellent tape 100 to the desired location without inadvertently adhering to a random location, remove the adhesive protective layer 108 and affix to the desired location. The adhesive protective layer 108 helps prevent waste of the vermin repellent tape 100.

The vermin repellent layer 104 has first face on the underside affixed to the second face of the backing 102. The vermin repellent layer 104 may be absorbent and retain the vermin repellent 114 until released by the user by removing the release protective layer 112 described herein. The vermin repellent layer 104 has may have sufficient capacity to retain the vermin repellent 114 for an extended period of time. Preferably, the vermin repellent 114 would persist in sufficient concentration for at least a month and preferably three to six months or longer to repel the vermin and other animals. In the preferred embodiment, the vermin repellent 114 may be formulated to repel mice, rats, and other animals such as squirrels, raccoons, opossums, and bats (herein after referred to as “vermin”), and the like that are likely to damage the equipment.

Many users leave equipment such as tractors in fields and barns until the next use. The equipment may not be used for days or even months allowing time for vermin to build a nest in the equipment and destroy the equipment in the process. Vermin may use part of the equipment wiring and other equipment parts of their nesting materials. Soft materials such as plastics and foam used in seats may also be desirable for vermin building their nest. In doing so, vermin destroy the equipment and, in many cases, create costly repairs for the user. Some devices well known in the art are chemicals and traps to catch and kill the vermin. However, these devices are usually placed in the equipment after the damage has been done. Even if these devices are placed before the vermin has a chance to damage the equipment, they rely on the vermin to trip the trap or eat the poison. For these traps to successfully work, baits may be used to attract the vermin. The unintended consequences is that the trap may attract additional unwanted vermin thus compounding the problem. Additionally, some of the vermin may be astute and avoid the traps. When the traps are successful, they may cause additional problems of a dead and decaying vermin that may not be detected in the equipment for days or months leading to an undesirable situation in the equipment.

One skilled in the art may select a vermin repellent 114 from several different volatile organic compounds (“VOC”) such as predator urine, naphthalene, and paradichlorobenzene. Each of these compounds may elicit a different response from the vermin but have the same effect of repelling the vermin. The predator urine may cause vermin to avoid the area for fear of becoming dinner for the predator. Naphthalene or paradichlorobenzene repels vermin as they do not like the smell and would tend to avoid the area where the chemicals are located.

The control release layer 110 has a first face on the underside affixed to the second face of the vermin repellent layer 104 thus substantially sealing the vermin repellent 114 within the vermin repellent layer 104 to prevent uncontrolled loss of the vermin repellent 114 before the desired use. The control release layer 110 may be permeable or semi-permeable, controlling the concentration of vapors or gases released by the vermin repellent 114 that pass through the control release layer 110. The control release layer 110 may also be perforated to enable and control the timely release of the vermin repellent 114. The control release layer 110 may allow for a quick release of the vermin repellent 114 and a slow release of the vermin repellent 114. Preferably, the vermin repellent tape 100 may allow for a combination thereof where the quick release sections 300 and slow release sections 302 may alternate on the same piece of tape allowing for an instant effect and for a sustained timed release. The control release layer 110 has a second face on the topside for releasably affixing a release protective layer 112.

The release protective layer 112 has a first face on the underside for releasably affixing to the second face of control release layer 110. Opposite of the first face of the release protective layer 112 is a second face to prevent damage to the control release layer 110, vermin repellent layer 104, and vermin repellent 114. The release protective layer 112 substantially covers the second face of the control release layer 110, until removed to release the vermin repellent 114. Additionally, the release protective layer 112 may be of sufficient width to substantially cover the edges of the control release layer 110 and vermin repellent layer 104 preventing an undesired loss of the vermin repellent 114, until user activates the tape. The release protective layer 112 is impermeable and may prevent unwanted loss of the vermin repellent 114. Additionally, different coatings may be applied to the second face of the release protective layer 112 to prevent environmental degradation of the control release layer 110, vermin repellent layer 104, and vermin repellent 114 including, but not limited to, ultraviolet and moisture protection.

The vermin repellent tape 100 is preferably in a geometric shape in the form of a rectangle with a longitudinal direction. This shape allows the vermin repellant tape 100 to be rolled in a common configuration for a tape. The length of the vermin repellent tape may be selectable by the user cutting the vermin repellent tape 100 to a desired length for use in a desired area to be protected. In other embodiments, the tape may be pre-cut to a preferred length or pre-scored along the length of the tape for ease of the user. Additionally, the vermin repellent tape 100 may include pre-cut strips and geometric shapes on a sheet. The vermin repellent tape 100 may be flexible to accommodate different shaped support areas within the desired location. While the rectangular shape may be the preferred shape for the vermin repellent tape 100, other shapes are within the scope of the present invention.

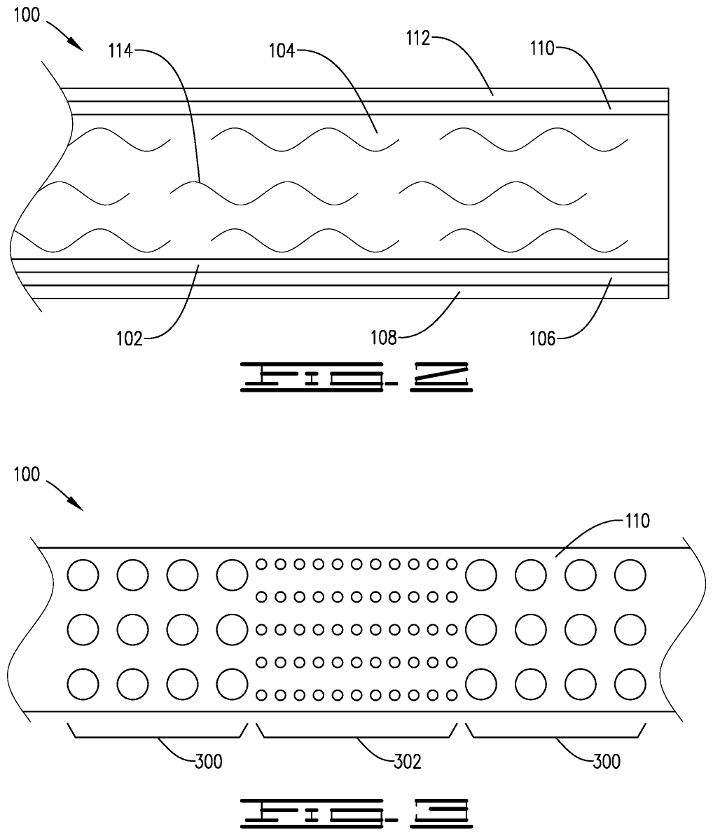

FIG. 2 is a cross-sectional view of the vermin repellent tape 100 of FIG. 1. The user may cut or tear a desired length of the vermin repellent tape 100 from the roll in the preferred embodiment. The user may position the selected piece of tape in the area of the equipment the user desires to protect. The user may then remove the adhesive protective layer 108 and press the tape to the desired support surface on the equipment. After the user secures the vermin repellent tape 100 to a support surface, the user then removes the release protective layer 112 to activate the vermin repellent tape 100 and allow vermin repellent 114 to emit through the control release layer 110. A user may also apply the vermin repellent tape 100 directly to equipment wiring for potentially improved protection.

One skilled in the art may change the thickness of the vermin repellent layer 104 to increase or decrease the longevity of the vermin repellent 114. The thinner the vermin repellent layer 104, the less vermin repellent 114 it may retain thus requiring the vermin repellent tape 100 being replaced more often. Conversely, the thicker the vermin repellent layer 104, the more vermin repellent 114 it may retain thus requiring the vermin repellent tape 100 being replaced less often.

FIG. 3 is a top view of the control release layer 110 of the vermin repellent tape 100. The control release layer 110 substantially covers the vermin repellent layer 104 and preferably prevents the unwanted release of the vermin repellent 114 from other than the desired areas and controls the timely release of the vermin repellent 114. The control release layer 110 preferably comprises alternating quick release sections 300 and slow release sections 302.

However, another embodiment may incorporate a quick release section 300 or a slow release section 302. The quick release section 300 of the control release layer 110 preferably has a series of openings that releases the vermin repellent 114 in a concentrated manner to quickly saturate the desired area to quickly repel the vermin. The amount of the vermin repellent 114 to be released may be determined by the size of the openings and number of openings and type of repellent. As shown in FIG. 3, the control release layer 110 preferably has a series of large circular openings that make up the quick release section 300 and a series of smaller circular openings that make up the slow release section 302. One skilled in the art may use different geometric shapes and sizes to control the release of the vermin repellent 114. The smaller circular and number openings of the slow release section 302 may provide a slower rate of release of the vermin repellent 114. The quick release section 300 preferably provides an initial concentration that causes the vermin to vacate the desired area and the slow release section 302 provides a persistent concentration of the vermin repellent 114 to keep the vermin away from the desired location for a period of time. The amount of time the vermin repellent tape 100 may be effective may be determined by one skilled in the art.

1. A vermin repellent tape comprising:
a. a backing having a first face on a topside and a second face on an underside;
b. an adhesive layer having a first face on a topside and a second face on an underside, where the first face is affixedly attached to the second face of the backing and substantially covers the second face of the backing;
c. a vermin repellent layer having a first face on a topside and a second face on an underside, where the second face is affixedly attached to the first face of the backing, configured for retaining and releasing a vermin repellent;
d. a control release layer having a first face on a topside and a second face on an underside, where the second face is affixed to the first face of the vermin repellent layer and substantially covers the first face of the vermin repellent layer and configured for controlling the vermin repellent released; and
e. the vermin repellent,
whereby the vermin repellent tape is configured for repelling vermin by affixing the tape to an equipment's support surface where the tape is constructed by combing multiple layers and adding a repellent material.

2. The tape of claim 1, where the backing is selected from two-dimensional geometric shapes.

3. The tape of claim 2, where the backing having a longitudinal direction with a first face and a second face, opposite of the first face.

4. The tape of claim 3, where the tape length is selectable.

5. The tape of claim 3, where the tape length is pre-cut to predetermined lengths.

6. The tape of claim 3, where the tape is replaced with sheet material.

7. The tape of claim 1, where the tape is flexible.

8. The tape of claim 1, where the backing is selected from a group of fabric, plastic, and cellulosic.

9. The tape of claim 1, where an adhesive substantially covers one face of the adhesive layer.

10. The tape of claim 9, where the adhesive is selected from a group of pressure sensitive, heat-activated, and water-based adhesives.

11. The tape of claim 1, where a removable adhesive protective layer substantially covers the adhesive layer.

12. The tape of claim 1, where the vermin repellent layer is absorbent to retain the vermin repellent.

13. The tape of claim 12 where the vermin repellent is selected from a group of volatile organic compound (“VOC”) consisting of predator urine, naphthalene, and paradichlorobenzene.

14. The tape of claim 1, where a control release layer covers substantially covers one face.

15. The tape of claim 1, where a control release layer is permeable and semipermeable to allow the vermin repellent to pass through at a controlled rate.

16. The tape of claim 15 where the control release layer release is selectable from a quick release and a slow release of the vermin repellent.

17. The tape of claim 1, where a release protective layer is a removable sheet that substantially covers the control release layer.

18. The tape of claim 1, where a release protective layer substantially covers the longitudinal edges of the tape.

19. A vermin repellent tape comprising:
a. a backing having a first face on a topside and a second face on an underside;
b. an adhesive layer having a first face on a topside and a second face on an underside, where the first face is affixedly attached to the second face of the backing and substantially covers the second face of the backing;
c. an adhesive protective layer having a first face on a topside and a second face on an underside, where the first face is releasably affixed to the second face of the adhesive layer and substantially covers the adhesive layer;
d. a vermin repellent layer having a first face on a topside and a second face on an underside, where the second face affixedly attached to the first face of the backing and substantially covers the first face of the backing, configured for retaining and releasing a vermin repellent;
e. a control release layer having a first face on a topside and a second face on an underside, where the second face is affixed to the first face of the vermin repellent layer and substantially covers the first face of the vermin repellent layer and configured for controlling the vermin repellent released;
f. release protective layer having a first face on a topside and a second face on an underside, where the second face is releasably affixed to the first face of the control release layer and substantially covers the first face of the control release layer; and
g. a vermin repellent,
whereby the vermin repellent tape is configured for repelling vermin by a user removing the adhesive protective layer and affixing the tape to an equipment's support surface and removing the release protective layer from the control release layer allowing for the rodent repellent to emit in the area where the tape was placed.

20. A vermin repellent tape comprising:
a. a backing having a longitudinal direction with a first face and a second face opposite said first face;
b. a vermin repellent substantially covers a first face; and
c. an adhesive substantially covers a second face,
whereby the vermin repellent tape is configured for repelling vermin by affixing the tape to an equipment's support surface and the tape is constructed by applying an adhesive to one face of the backing and applying a vermin repellent to the opposite face.

21. The tape of claim 20, where a removable adhesive protective layer substantially covers the adhesive layer.

22. The tape of claim 20, where a release protective layer substantially covers the longitudinal edges of the tape.

23. A method of repelling vermin comprising the steps of:
selecting a desired amount of the vermin repellent tape;
cutting or tearing said vermin repellent tape to a desired length;
affixing said vermin repellent tape to a supporting surface in a desired location;
releasing a protective layer to activate said vermin repellent tape and to release a vermin repellent.

24. The method according to claim 23 wherein:
said step of affixing said vermin repellent tape comprises applying vermin repellent tape directly to equipment wiring.

25. The method according to claim 23 wherein:
said vermin repellent tape has an adhesive layer, a backing, a vermin repellent and a release layer.

26. The method according to claim 23 wherein:
said vermin repellent persists in sufficient concentration for at least a month.

27. The method according to claim 26 wherein:
said vermin repellent persists three to six months

28. The method according to claim 26 wherein:
said vermin repellent persist for greater than 6 months.

29. The method according to claim 23 wherein:
said vermin repellent is formulated to repel vermin selected from a group consisting of mice, rats, squirrels, raccoons, opossums, and bats.

30. The method according to claim 23 wherein:
said vermin repellent is comprised of volatile organic compounds.

31. The method according to claim 30 wherein:
the volatile organic compounds are selected from a group consisting of predator urine, naphthalene, and paradichlorobenzene.
